(19) United States
(12) Patent Application Publication
(10) Pub. No.: US 2016/0023494 A1
(43) Pub. Date: Jan. 28, 2016

(54) CONTINUOUS DESK PAD

(71) Applicant: ACCO BRANDS CORPORATION, Lake Zurich, IL (US)

(72) Inventors: Megan M. Meyer, Waxhaw, NC (US); Thomas J. Africa, Lebanon, OH (US); Sherry L. Jones, Pataskala, OH (US); Edward P. Busam, Mason, OH (US); Lisa K. Brooks, West Chester, OH (US); Danielle L. Osborne, Dayton, OH (US)

(21) Appl. No.: 14/339,758

(22) Filed: Jul. 24, 2014

(51) Int. Cl. B42D 5/06

(52) U.S. Cl. CPC B42D 5/06; B42D 5/065

(57) ABSTRACT

The present invention provides a calendar desk pad, comprising a base member, a plurality of monthly calendar pages bound to the base member, wherein the calendar pages have at least one perforation or fold line located between the days or weeks on the calendar.

### REFERENCE TO RELATED APPLICATIONS

This application is a continuation of U.S. patent application Ser. No. 13/395,967 filed Mar. 14, 2012, which is a National Phase application of PCT Application No. PCT/US10/047424 filed Sep. 1, 2010, which claims the benefit of priority under 35 U.S.C. §119(e) of U.S. Provisional Application Ser. No. 61/260,964 filed on Nov. 13, 2009 each of which is hereby incorporated by reference in their entirety.

### FIELD OF THE INVENTION

The present invention relates generally to desk pads and more particularly a calendar desk pad.

### BACKGROUND OF THE INVENTION

The current invention is an improvement on the traditional desk pad calendar. On these calendars it is common to have several pages attached together with a single month on each page. Accordingly a user can only see one month at a time without flipping pages. This inability to see into the next month without remembering to look ahead makes it difficult for the user to remember meetings, appointments, and/or due dates occurring early in the next month. The current invention creates a user friendly calendar that allows the user to remove or fold a portion of the current month from their view after the time period has passed, thus allowing the user to view the upcoming days and/or weeks in the next month.

### BRIEF SUMMARY OF THE INVENTION

The present invention provides a calendar desk pad, comprising a base and a plurality of calendar sheets removably attached to the base and lying in stacked, respective planes that overlie the base and a perforated line separating at least one calendar week from the remainder of the page. The present invention also contemplates a calendar desk pad, comprising a base and a plurality of calendar sheets removably attached to the base and lying in stacked, respective planes that overlie the base and a fold line separating at least one calendar week from the remainder of the page. The present invention also contemplates a calendar sheet having a single month on the sheet and having a perforation following at least one week in the month. The present invention also contemplates a calendar sheet having a single month on the sheet and having a fold line following at least one week in the month.

### DESCRIPTION OF THE DRAWINGS

FIG. 1 is a top view of the present invention.

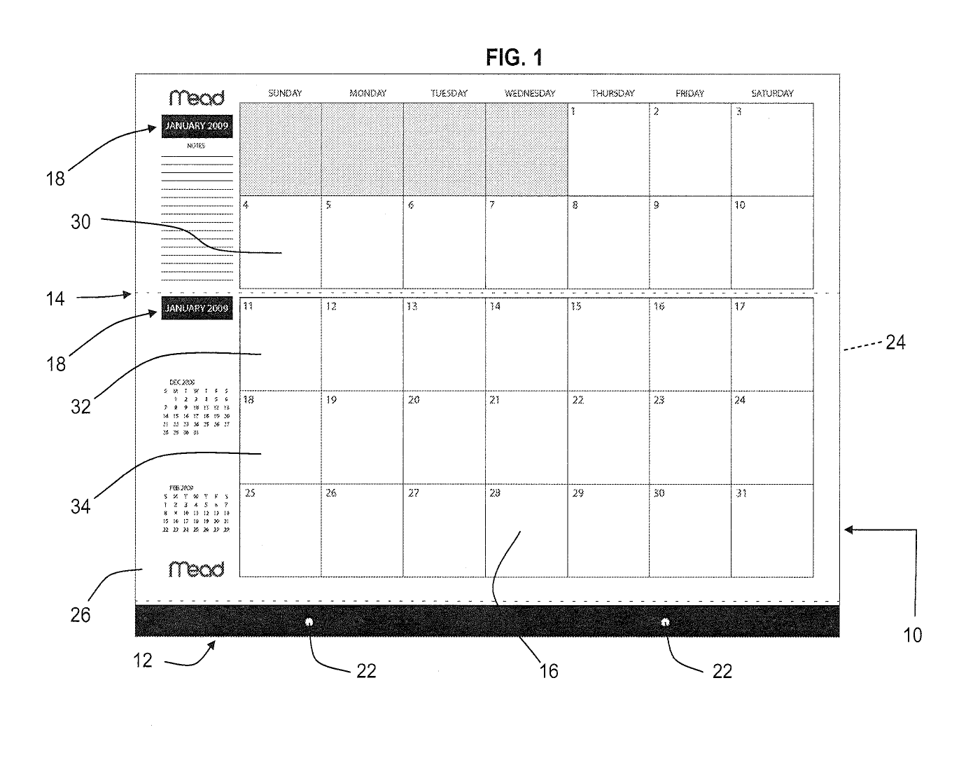

FIG. 2 is a top view of an alternate form of the present invention.

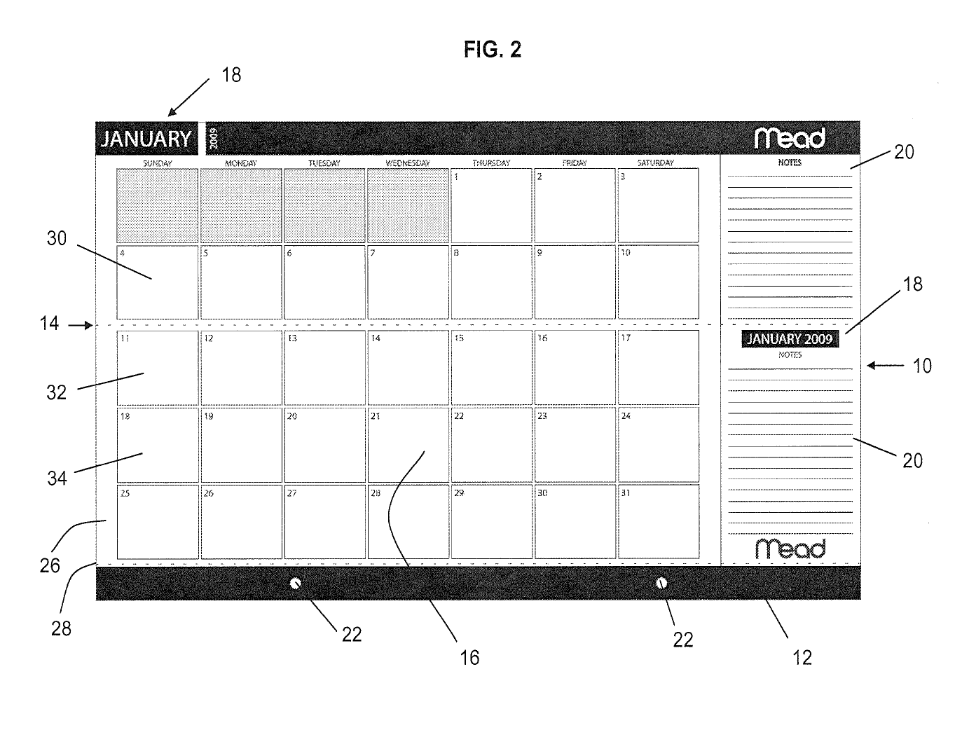

### DETAILED DESCRIPTION OF THE INVENTION

Referring to the figures, the continuous calendar 10 of the current invention may have a plurality of pages 24 bound together on one or more sides by one or more binding mechanism(s) 12 and where the plurality of pages comprise two or more calendar pages 26 and wherein one or more calendar pages 26 may have one or more perforations or fold lines 14 that allow a portion of the page to be removed or folded. The calendar page 26 may have a traditional month calendar format with the month indicator 18 placed in one or more locations of each calendar page 26 and showing each day of the month. Such a calendar page 26 may have a space designated to allow the user to fill in appointments or the like on each day. The desk pad calendar of the present invention may also have one or more spaces 20 on a calendar page to allow the user to write notes or comments. Such calendar page 26 may also have a space to view previous and following months.

The continuous desk pad 10 may have its binding mechanism 12 located across the bottom of the desk pad as compared to the calendar orientation. Such a location may allow the user to more easily remove or fold an upper portion of the calendar page 26 along line 14. Line 14 may be perforated to allow the user to easily remove that portion of the calendar page 26. Line 14 may also be manufactured such that the calendar page 26 creases easily in that location by using score lines. There are a variety of methods to manufacture a removable portion of the page or an easily folded portion of a page. Some methods may include the use of spaced breaks in the page, perforations, holes, weakened spots in the page, embossing, debossing or any combination or these. The appropriate method to use may be determined by manufacturing preferences.

Line 14 may be designed to run parallel to the orientation of the weeks on the calendar page 26. Line 14 may be located beneath the first full week 30 of the month. Line 14 may be located beneath the second full week 32 of the month. Line 14 may be located beneath the third full week 34 of the month. Multiple lines 14 may be placed on each calendar page. The calendar pages 26 may have two or more perforations. The perforations or score lines of line 14 may extend across the majority of calendar sheet 26 to more easily allow the user to fold or separate the top portion of the page.

The calendar page 26 may be removably attached to binding 12. Perforations 28 may be placed along the edge of binding mechanism 12. It is to be understood that score lines could be used in lieu of perforations to allow to user to more easily fold back the pages of the desk pad calendar. In the alternative binding mechanism 12 could be located at two or more corners. The binding mechanism 12 may be cardboard or plastic. Binding mechanism 12 may be comprised of adhesive material, paper, fabric, staples, wire, spiral, tape or stitching. The two or more corner binding mechanism(s) 12 may be triangular, round or any other shape. They may also be paper, wire, staples, adhesive, tape, fabric stitching or any other similar materials or combinations thereof. One or more of the corner binding mechanism 12 may be removably attached, loosely holding the plurality of pages 26 together.

It is to be understood that the desk pad calendar may be of a variety of sizes and shapes based on manufacturing preferences. The desk pad calendar may be rectangular, square, round, oval triangular, star shaped or any other geometric or non-geometric shape. It is to be understood that based on the traditional calendar organization the rectangular shape may have some benefits.

The desk pad calendar could be sized and shaped to be portable. The desk pad may be sized and shaped to fit within a notebook with holes 22 drilled into the binding. In this design it may be preferable to have the perforations 28 or fold line 28 to remove or fold the one or more calendar pages 16 located inside of the holes 22. The calendar itself may be foldable as described in U.S. Publication 20070089331. The benefits of portability would allow a user to easily take the calendar into the classroom or into meetings as needed.

The calendar dimensions could have a height or distance from the one or more binding mechanism(s) 12 to the edge of equal to or less than 10 inches, of equal to or less than 15 inches, of equal to or less than 25 inches, or greater than 25 inches. The desk pad calendar may have a width parallel to the one or more binding mechanism(s) 12 of equal to or less than 10 inches, of equal to or less than 15 inches, of equal to or less than 25 inches, or greater than 25 inches. The desk pad calendar may have a width greater than its height.

It is also to be understood that a calendar sheet could be made that includes the features described previously of the current invention. Namely, the invention contemplates a calendar sheet with a monthly calendar printed thereon and having a fold line 14. The calendar sheet as discussed may have a perforated line 14 which would allow a portion of the calendar sheet to be removed.

It should be understood that changes may be made to the invention described herein without departing from the full scope and spirit of the present invention as set forth in the claims below.

1. A calendar desk pad comprising:
a base;
a plurality of pages removably attached to the base, wherein the plurality of pages comprise two or more calendar pages;
a binding mechanism, which binds the plurality of pages together, wherein the binding mechanism is located at the bottom of the desk pad; and
wherein the two or more calendar pages each have at least a first and second perforation.

2. The calendar desk pad of claim 1 wherein the calendar page displays a traditional calendar month.

3. The calendar desk pad of claim 2 wherein one or more perforations is located underneath the first full week of the traditional month calendar.

4. The calendar desk pad of claim 2 wherein one or more perforations is located underneath the second full week of the traditional month calendar.

5. The calendar desk pad of claim 1 wherein the binding means is located at two or more corners.

6. The calendar desk pad of claim 5 wherein the binding means is triangular.

7. The calendar desk pad of claim 6 wherein the binding means is plastic.

8. The calendar desk pad of claim 1 wherein there are two perforations on the calendar pages.

9. The calendar desk pad of claim 8 wherein one perforation is in the top third of the calendar furthest from the binding mechanism and the other perforation is in the bottom third closest to the binding mechanism.

10. The calendar desk pad of claim 8 wherein on perforation is in the top third of the calendar furthest from the binding mechanism and the other perforation is in the bottom half closest to the binding mechanism.

11. A calendar desk pad comprising:
a base;
a plurality of pages removably attached to the base, wherein the plurality of pages comprise two or more calendar pages;
a binding mechanism, which binds the plurality of pages, wherein the binding mechanism is located at the bottom of the desk pad; and
wherein the two or more calendar pages have at least a first and second fold line.

12. The calendar desk pad of claim 11 wherein the calendar page displays a traditional calendar month.

13. The calendar desk pad of claim 12 wherein one or more fold lines is located underneath the first full week of the traditional month calendar.

14. The calendar desk pad of claim 12 wherein one or more fold lines is located underneath the second full week of the traditional month calendar.

15. The calendar desk pad of claim 12 wherein the binding means is located at two or more comers.

16. The calendar desk pad of claim 15 wherein the binding means is triangular.

17. The calendar desk pad of claim 11 wherein there are two fold lines on the calendar pages.

18. The calendar desk pad of claim 17 wherein one fold line is in the top third of the calendar furthest from the binding mechanism and the other fold line is in the bottom half closest to the binding mechanism.

19. The calendar desk pad of claim 17 wherein one fold line is in the top third of the calendar furthest from the binding mechanism and the other fold line is in the bottom half closest to the binding mechanism.

20. A calendar desk pad comprising:
a base;
a plurality of pages removably attached to the base, wherein the plurality of pages comprise two or more calendar pages;
a binding mechanism, which binds the plurality of pages together, wherein the binding mechanism is located at the bottom of the desk pad; and
wherein the one or more calendar pages has at least one fold line and at least one perforation.
